(19) United States
(12) Patent Application Publication
(10) Pub. No.: US 2009/0310972 A1
(43) Pub. Date: Dec. 17, 2009

(54) CIRCUIT CARD SUBASSEMBLIES FOR INTERCONNECTION OF ELECTRONIC COMPONENTS

(75) Inventors: Michael J. Wayman, Waconia, MN (US); Gregory Martell, Chanhassen, MN (US); Eric S. Moreau, St. Peter, MN (US)

Correspondence Address: FOGG & POWERS LLC, 5810 W 78TH STREET, SUITE 100, MINNEAPOLIS, MN, 55439, US

(73) Assignee: ADC TELECOMMUNICATIONS, INC., Eden Prairie, MN (US)

(21) Appl. No.: 12/427,030

(22) Filed: Apr. 21, 2009

Related U.S. Application Data
(60) Provisional application No. 61/060,762, filed on Jun. 11, 2008.

(51) Int. Cl. H04B 10/00; G08B 21/00

(52) U.S. Cl. 398/115; 340/540

(57) ABSTRACT

A communication system is provided. The communication system includes a serialized radio frequency transceiver module and at least one radio frequency module. The serialized radio frequency transceiver module includes a plurality of optical-module connectors, and a remote serialized radio frequency interface including a plurality of high speed connectors. Each of the at least one radio frequency module includes an interface configured to be coupled to the remote serialized radio frequency interface of the serialized radio frequency transceiver module to pass and receive data signals, and a remote digital-analog radio transceiver input interface coupled to the interface. The remote digital-analog radio transceiver input interface is configured to pass data signals to and from the at least one radio frequency module.

This application claims the benefit of U.S. Provisional Application No. 61/060,762, filed on Jun. 11, 2008, which is incorporated herein by reference in its entirety.

### RELATED APPLICATIONS

This application is related to the following co-pending United States patent applications filed on even date herewith, all of which are hereby incorporated herein by reference:

U.S. patent application Ser. No. 12/137,322, titled “COMMUNICATION MODULES” and which is referred to here as the '322 Application;

U.S. patent application Ser. No. 12/137,297, titled “APPARATUS FOR MOUNTING A MODULE AND ENABLING HEAT CONDUCTION FROM THE MODULE TO THE MOUNTING SURFACE” and which is referred to here as the '297 Application;

U.S. patent application Ser. No. 61/060,589, titled “SUSPENSION METHOD FOR COMPLIANT THERMAL CONTACT OF ELECTRONIC MODULES” and which is referred to here as the '589 Application;

U.S. patent application Ser. No. 12/137,307, titled “ANGLED DOORS WITH CONTINUOUS SEAL” and which is referred to here as the '307 Application;

U.S. patent application Ser. No. 61/060,523, titled “L-SHAPED DOOR WITH THREE-SURFACE SEAL FOR ENDPLATES” and which is referred to here as the '523 Application;

U.S. patent application Ser. No. 61/060,576, titled “L-SHAPED DOORS WITH TRAPEZOIDAL SEAL” and which is referred to here as the '576 Application;

U.S. patent application Ser. No. 12/137,309, titled “SYSTEMS AND METHODS FOR VENTURI FAN-ASSISTED COOLING” and which is referred to here as the '309 Application;

U.S. patent application Ser. No. 61/060,547, titled “COMBINATION EXTRUDED AND CAST METAL OUTDOOR ELECTRONICS ENCLOSURE” and which is referred to here as the '547 Application;

U.S. patent application Ser. No. 61/060,584, titled “SYSTEMS AND METHODS FOR CABLE MANAGEMENT” and which is referred to here as the '584 Application;

U.S. patent application Ser. No. 61/060,581, titled “CAM SHAPED HINGES” and which is referred to here as the '581 Application;

U.S. patent application Ser. No. 12/137,313, titled “SOLAR SHIELDS” and which is referred to here as the '313 Application;

U.S. patent application Ser. No. 61/060,501, titled “APPARATUS AND METHOD FOR BLIND SLOTS FOR SELF DRILLING/SELF-TAPPING SCREWS” and which is referred to here as the '501 Application;

U.S. patent application Ser. No. 61/060,593, titled “SYSTEMS AND METHODS FOR THERMAL MANAGEMENT” and which is referred to here as the '593 Application; and

U.S. patent application Ser. No. 61/060,740 entitled “PULL-OUT SHELF FOR USE IN A CONFINED SPACE FORMED IN A STRUCTURE” and which is referred to here as the '740 Application.

### BACKGROUND

Radio frequency (RF) communication systems that receive and send signals typically include devices such as a radio transceiver, a filter and power amplifier. Each device has to be selected to work with the other devices. Likewise, in the field of telecommunications, there is a trend to reduce both the size and the expenses associated with infrastructure equipment. The result is a demand on providers of telecommunications infrastructure equipment to provide suitably sized equipment that operates in a more cost effective manner, while retaining all the functionality of legacy equipment. The modularity of designs proposed for such equipment, along with the sizes desired by system operators, introduces new challenges with respect to ease of installation, ease of interconnecting various modules, and ease of maintenance. For example, these proposed designs will need to have ways to communicatively couple the various modular components in a cabinet and to re-couple the modular components in a cabinet when one of the modules or more of the modules in the cabinet are replaced. Hence, putting together a working communication system that works as desired takes some effort.

For the reasons stated above and for other reasons stated below which will become apparent to those skilled in the art upon reading and understanding the specification, there is a need in the art for improved systems and methods for cable management in electronics enclosures.

### SUMMARY

The present application relates to a communication system. The communication system includes a serialized radio frequency transceiver module and at least one radio frequency module. The serialized radio frequency transceiver module includes a plurality of optical-module connectors and a remote serialized radio frequency interface including a plurality of high speed connectors. Each of the at least one radio frequency modules includes an interface configured to be coupled to the remote serialized radio frequency interface of the serialized radio frequency transceiver module to pass and receive data signals and a remote digital-analog radio transceiver input interface coupled to the interface. The remote serialized radio frequency interface is configured to pass data signals to and from the at least one radio frequency module.

The present application also relates to a serialized radio frequency transceiver module. The serialized radio frequency transceiver module includes a plurality of optical-module connectors, and a remote serialized radio frequency interface including a plurality of high speed connectors. The serialized radio frequency transceiver module also includes a serialized radio frequency circuit board communicatively coupling the plurality of optical-module connectors to the remote serialized radio frequency interface. The serialized radio frequency transceiver module is configured to pass signals to and from at least one radio frequency (RF) module housed in a cabinet with the serialized radio frequency transceiver module.

The present application also relates to a method of connecting electronic modules installed in a cabinet. The installed electronic modules form a communication system. The method includes connecting at least one optical-module connector of a serialized radio frequency transceiver module to a respective at least one optical fiber, connecting the at least one optical-module connector to an associated at least one high speed connector on a remote serialized radio frequency interface of the serialized radio frequency transceiver module, and connecting the at least one high speed connector on the remote serialized radio frequency interface to external connectors on an interface of a radio frequency module via interconnect cables. The radio frequency module and the serialized radio frequency transceiver module are communicatively coupled to send signals to and from each other. The serialized radio frequency transceiver module is communicatively coupled to send signals to and from at least one external-optical-fiber cable, and the radio frequency module is communicatively coupled to send signals to and from at least one antenna.

The present application also relates to a communication system. The communication system includes a multiplexer/serializer module and at least one radio frequency digitizer module. The multiplexer/serializer module includes a plurality of optical-module connectors and a remote multiplexer/serializer interface including a plurality of high speed connectors. Each of the at least one radio frequency digitizer modules includes an interface configured to be coupled to the remote multiplexer/serializer interface of the multiplexer/serializer module to pass and receive data signals and a remote radio frequency digitizer input interface coupled to the interface. The remote multiplexer/serializer interface passes data signals to and from the at least one radio frequency digitizer module.

The details of various embodiments of the claimed invention are set forth in the accompanying drawings and the description below. Other features and advantages will become apparent from the description, the drawings, and the claims.

### DRAWINGS

FIG. 1A is a block diagram of an embodiment of a distributed antenna system including a communication system in accordance with the present invention;

FIGS. 1B and 1C are perspective views of an embodiment of a communication system in accordance with the present invention;

FIG. 1D is an enlarged view of connectors and cables in the communication system of FIG. 1C;

FIG. 2A is a view of an embodiment of a serialized radio frequency (SeRF) transceiver module in accordance with the present invention;

FIG. 2B is an illustration of a remote serialized radio frequency (SeRF) interface of the SeRF transceiver module of FIG. 2A;

FIG. 3A is a side perspective view of an embodiment of an RF module in accordance with the present invention;

FIG. 3B is a side perspective view of the RF module of FIG. 3A with side panels removed;

FIG. 3C is an illustration of the interconnect cables inside the RF module of FIG. 3A;

FIG. 3D is an illustration of a printed circuit board assembly interface of the RF module of FIG. 3A;

FIG. 3E is an illustration of a remote digital-analog radio transceiver input (RDI) interface of the RF module of FIG. 3A; and

FIG. 4 is a flow diagram of an embodiment of a method of connecting electronic modules installed in a cabinet to form a communication system.

Like reference numbers and designations in the various drawings indicate like elements.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense, and the scope of the present invention is defined only by the claims and equivalents thereof.

Embodiments of the present invention provide a serialized radio frequency transceiver module (SeRF transceiver module) that fits into a communication cabinet that includes radio frequency (RF) modules. In embodiments, the SeRF transceiver module is between each of the RF modules and the external data sources. The SeRF transceiver module also controls the RF modules. The SeRF transceiver modules described herein are multiplexer/serializer modules from which multiple streams of digitized radio frequency signals are transported. The RF modules described herein are RF digitizer modules.

Further embodiments include interfaces and cabling that provide user friendly access. In particular, in embodiments, interface circuit card subassemblies (CCSAs) or printed circuit board assemblies (PCBAs) (or interfaces) provide interconnectivity of electronic components in each module (e.g., SeRF transceiver module and RF modules) and connectivity for the end-user to interface the system. These interfaces help ease the connectivity that production personnel face in assembly of the product as well as the connectivity an end user faces in field service. Moreover, the interfaces are beneficial when upgrading modules of the system because they limit the number of connections that need to be changed or reconnected. The interfaces also help facilitate an overall size reduction of the system by predefining connector locations. This allows all interface cables and/or wires to be affixed to the structure of the modules or enclosure prior to the closing of the enclosures access doors, or door, while greatly reducing the risk of broken, pinched or otherwise damaged cables or wires.

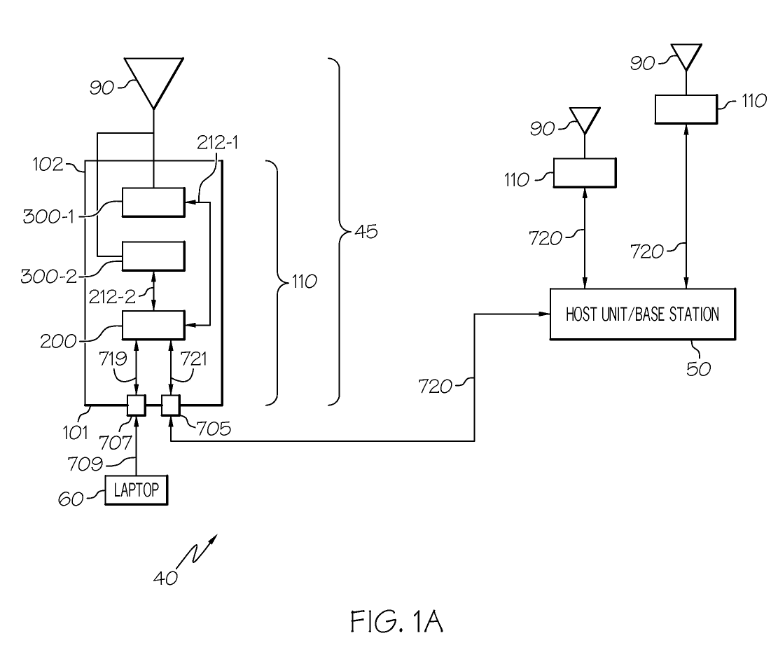

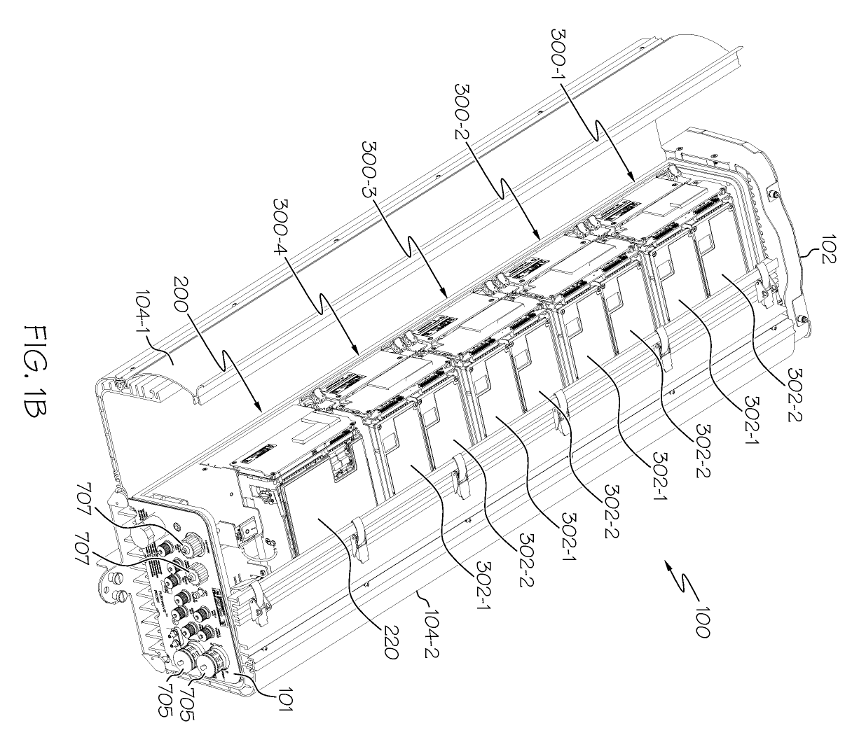

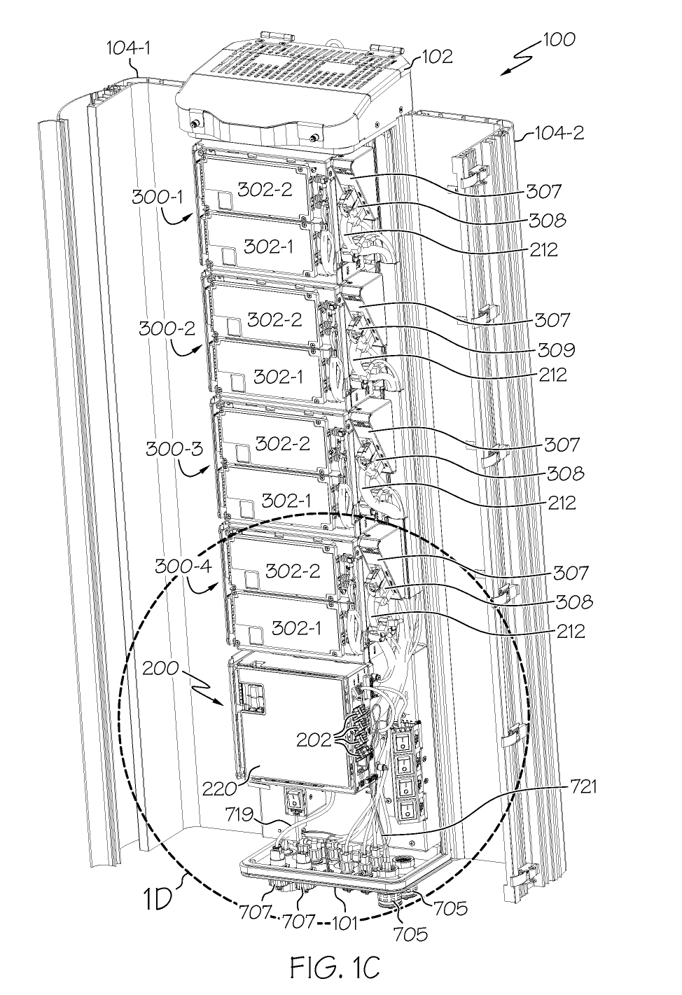

FIG. 1A is a block diagram of an embodiment of a distributed antenna system (DAS) 40 including a plurality of communication systems 110 in accordance with the present invention. The DAS 40 also includes an antenna 90 that is communicatively coupled to the communication system 110. Each communication system 110 includes at least one radio frequency (RF) module and a serialized radio frequency (SeRF) transceiver module. The communication system 110 that is shown in an expanded view includes two radio frequency (RF) modules 300(1-2), and a serialized radio frequency (SeRF) transceiver module 200.

The serialized radio frequency (SeRF) transceiver module 200 is also referred to herein as “a multiplexer/serializer module 200.” The RF modules 300(1-2) are also referred to herein as “digital-analog radio transceiver (DART) modules 300(1-2)” or “radio frequency digitizer modules 300(1-2).” The SeRF transceiver module 200 is attached to (or plugged into) the cabinet 102 in a first position (e.g., a bottom position). The RF module 300-1 is attached to the cabinet 102 in a second position (e.g., a top position) and the RF module 300-2 is attached to the cabinet 102 in a third position (e.g., a middle position). In this embodiment, since the communication system 110 is remotely located from a communicatively coupled base station or host unit 50, the serialized radio frequency transceiver module 200 is a remote SeRF transceiver module 200 and the DART module 300 is a remote DART module 300 (also referred to herein as a remote RF module 300.)

The SeRF module 200 is communicatively coupled to send signals to and from the host unit/base station 50 via external-optical-fiber cable 720. Within the cabinet 102, the remote RF modules 300(1-2) are communicatively coupled to send signals to and from the SeRF transceiver module 200. The RF modules 300(1-2) are communicatively coupled to send signals to and from at least one antenna 90 that is external to the cabinet 102.

On the uplink (from remote antenna unit 45 to base station/host unit 50), the RF modules 300(1-2) in the communication system 110 receive uplink RF signals from the at least one communicatively coupled RF antenna 90 and digitize the analog signals to digital data associated with the analog signals. The digital data is sent from the RF modules 300(1-2) to the remote SeRF transceiver module 200 by interconnect cables 212(1-2), respectively. The remote SeRF transceiver module 200 processes the digital data by formatting the digital data for transmission as a transport signal on the external-optical-fiber cable 720 to the base station 50. The remote SeRF transceiver module 200 sends the processed digital data via optical fiber 721 to the optical-cabinet connector 705 on panel 101 of the cabinet 102. The external-optical-fiber cable 720 is communicatively coupled to the optical fiber 721 via the optical-cabinet connector 705. The host unit/base station 50 receives the uplinked digital signals and reconstructs the analog uplink signals for radiation from the respective host unit or base station 50.

On the downlink (from base station/host unit 50 to remote antenna unit 45), the host unit/base station 50 receives analog RF signals, and sends digitized transport signals to the remote SeRF transceiver module 200 via external-optical-fiber cable 720. The remote SeRF transceiver module 200 processes the received digital data by formatting the received transport signal for the remote RF module 300. The remote SeRF transceiver module 200 sends the processed digitized signals to the appropriate one of the remote RF modules 300(1-2) via interconnect cables 212(1-2). The remote RF modules 300(1-2) reconstruct the analog downlink signals for radiation from the remote antenna 90.

In one implementation of this embodiment, the remote SeRF transceiver module 200 controls the functions of the remote RF modules 300(1-2). For example, in embodiments, the remote SeRF transceiver module provides instructions to set the data rates of the remote RF modules 300(1-2), controls the output power of the signals sent from the remote RF modules 300(1-2) to the remote antenna 90, and/or controls the output power of the signals sent from remote RF modules 300(1-2) to the remote SeRF transceiver module 200. In another implementation of this embodiment, the RF modules 300(1-2) are embodiments of the communication module described in the '322 Application.

The monitor connector 707 connects internal-monitor cable 719 to external-monitor cable 709 (also referred to herein as “Ethernet cable 709” and/or “support data link 709”). The external-monitor cable 709 transports monitoring signals to and from a portable device 60, such a laptop 60, when a user is troubleshooting or commissioning the communication system 110 at a remote location. As defined herein, monitoring signals include support signals, commissioning signals, test signals, and/or alarm signals that are used in the commission, support, and/or maintenance of the communication system 110. In one implementation of this embodiment, the internal-monitor cable 719 (also referred to herein as a “jumper cable 719) is not always installed in the cabinet 102. In that case, when the communication system 110 is to be commissioned, tested, or monitored, the doors 104-1 and 104-2 are opened and the jumper cable 719 is installed at that time.

In one implementation of this embodiment, the optical-cabinet connector 705 provides a throughput-hole for the external-optical-fiber cable 720 that includes the optical fiber 721. In another implementation of this embodiment, the monitor connector 707 provides a throughput-hole for the internal-monitor cable 719, which, in such an embodiment, is the external-monitor cable 709. In yet another implementation of this embodiment, the external-monitor cable 709 is a high-speed signal cable and signals at a high rate are transported to and from the laptop 60 or other test/support device. In such an embodiment, the internal-monitor cable 719 is a high-speed internal-monitor cable 719 to transport signals at the high data rates. In yet another implementation of this embodiment, the external-monitor cable 709 is a not high-speed signal cable and signals at a relatively low data rate are transported to and from the laptop 60 or other test/support device. In such an embodiment, the internal-monitor cable 719 is an internal-monitor cable 719 to transport signals at the lower data rates.

Internal-monitor cable 719 connects from the SeRF module 200 to the monitor connector 707 (also referred to herein as a bulkhead gigabit Ethernet port 707). One or more monitor connectors 707 are accessed at the remote location by a craft person with a portable test/support device to allow troubleshooting and commissioning at the site.

FIGS. 1B and 1C are perspective views of an embodiment of a communication system 100 in accordance with the present invention. The communication system 100 includes a cabinet 102 that has two doors 104-1 and 104-2 and a panel 101 on which the optical-cabinet connectors 705 and the monitor connectors 707 are positioned. The two doors 104-1 and 104-2 open to allow access to the components (i.e., SeRF transceiver module 200 and RF modules 300) housed therein and close to protect the components housed therein from the external environment.

FIG. 1B provides an external view of optical-cabinet connectors 705 and the monitor connectors 707 on the panel 101 of the cabinet 102. Both the doors 104-1 and 104-2 of the cabinet 101 are open in FIG. 1C to provide a view of: 1) the interconnect cables 212 and connectors 308 and 309 used to interface the RF modules 300 with the SeRF transceiver module 200; and 2) the internal-monitor cable 719, optical fibers 721, and optical-module connectors 202. In this embodiment, the components in the communication system 100 include a SeRF transceiver module 200 and four RF modules 300(1-4). The SeRF transceiver module 200 includes a SeRF circuit board 220. Although four DART modules 300(1-4) are illustrated in FIG. 1B, it will be understood that fewer or more DART modules 300 can be inserted in the cabinet 102. Each DART module 300 includes transceivers 302-1 and 302-2. In one implementation of this embodiment, the doors 104-1 and 104-2 are embodiments of the doors described in the '307 Application, the '523 Application, or the '576 Application. In another implementation of this embodiment, the cabinet 102 is embodiments of the cabinet described in the '547 Application.

FIG. 1D is an enlarged view of connectors and cables in the communication system 100 of FIGS. 1A and 1C. The optical-cabinet connector 705 couples an external-optical-fiber cable 720 carrying the optical signals to and from a host unit/base station 50 to the communication system 100. In one implementation of this embodiment, the external-optical-fiber cable 720 shown in FIG. 1D include a plurality of optical fiber bundles, which each include a plurality of optical fibers. In another implementation of this embodiment, the external-optical-fiber cable 720 shown in FIG. 1D is an optical fiber bundle.

The monitor connector 707 couples an external-monitor cable 709 to a portable device 60 (FIG. 1A) on-site for trouble shooting or commissioning of the communication system 110. The monitoring signals are sent between communication system 100 and to the portable device 60. The signals sent from the communication system 100 to the laptop 60 are responsive to the support, commissioning, monitoring, test, and/or alarm signals. In one implementation of this embodiment, the monitor connector 707 is a gigabit Ethernet connector 707 and the external-monitor cable is an Ethernet cable 709.

The optical-module connectors 202 of the SeRF transceiver module 200 are external to the SeRF transceiver module 200 but are internal to the cabinet 102 when the SeRF transceiver module 200 is mounted in the cabinet 102 and the doors 104-1 and 104-2 are closed. The optical-module connectors 202 are easily accessible when the door 104-2 is open. In embodiments, the optical-module connectors 202 need only be dealt with during production unless a repair is needed. As shown in FIGS. 1C and 1D, the optical-module connectors 202 are configured so that the plug-in face is facing upward away from the panel 101 on which the optical-cabinet connector 705 is located. In other embodiments, optical-module connectors 202 are configured so that the plug-in face is facing downward toward from the panel 101.

The optical-module connectors 202 receive data from outside the communication system 110 and pass data to the RF module 300. For example, in this embodiment, optical-module connectors 202 are optical transceivers (cages) to receive and transmit optical signals. In operation, one of the optical-module connectors 202 on the SeRF transceiver module 200 is optically coupled to a respective one of the optical fibers 721. In order for that connection to occur, the end face of the optical fiber 721 is fitted with any appropriate coupling component to permit optical coupling between the end face of the optical fiber 721 and the optical-module connector 202. Likewise, the end face of the optical fiber 721 is fitted with an appropriate component that fits in the optical-cabinet connector 705, to provide optical coupling between the end face of the optical fiber 721 and a respective one of the optical fibers in the external-optical-fiber cable 720.

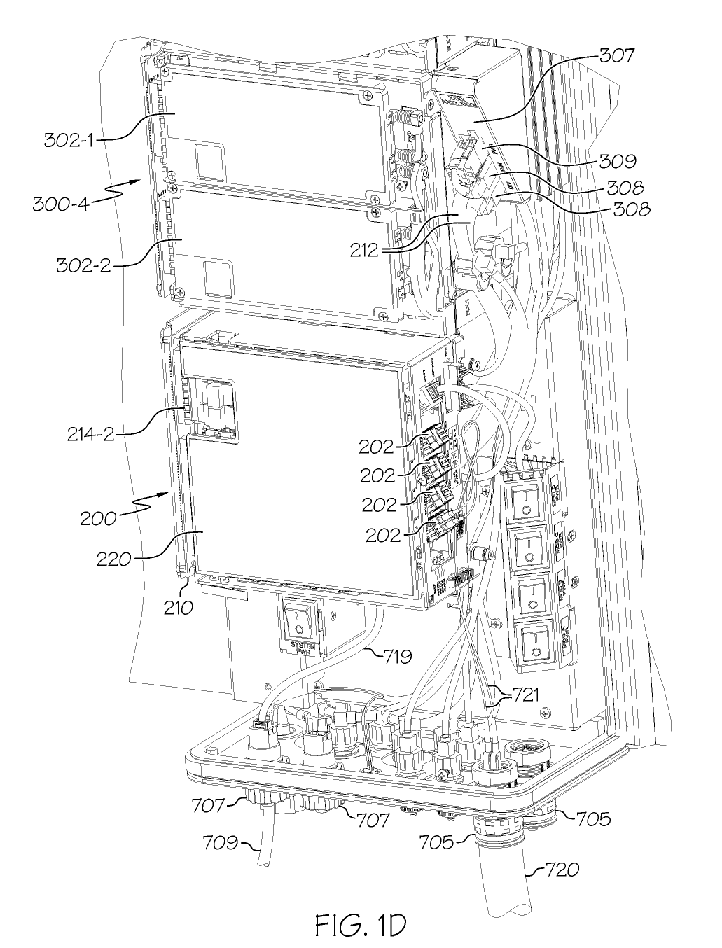

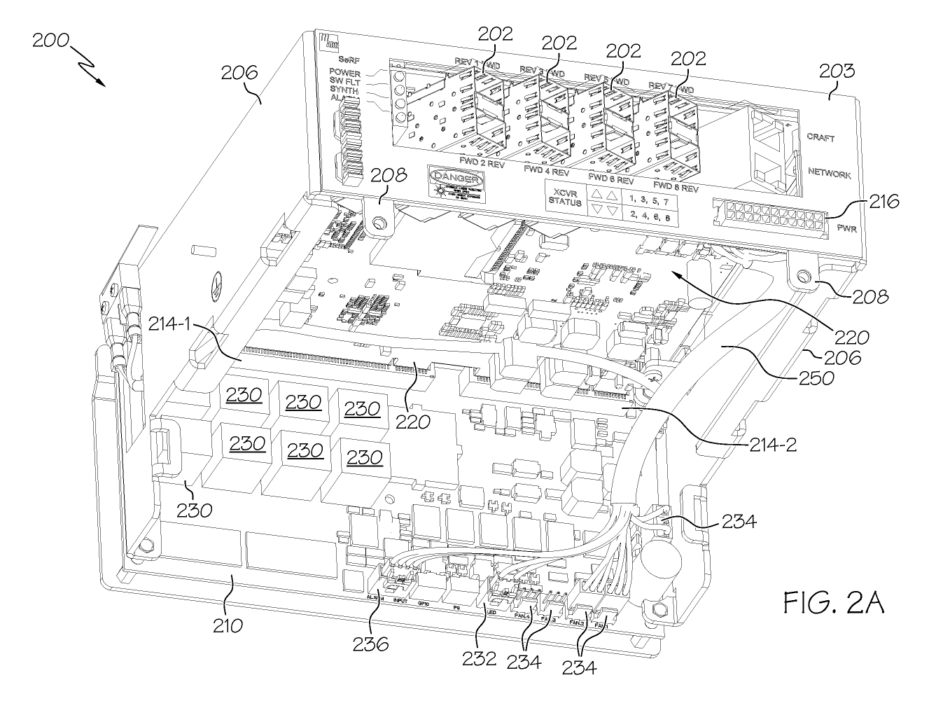

FIG. 2A is a view of an embodiment of a SeRF transceiver module 200 in accordance with the present invention. The view of the SeRF transceiver module 200 in FIG. 2A is from the opposite side of the view of the SeRF transceiver module 200 in FIG. 1D, so the inside of the SeRF transceiver module 200 in viewed in FIG. 2A. The SeRF transceiver module 200 is composed of side supports 206, the SeRF circuit board 220, a remote serialized radio frequency interface 210, and a panel 203 holding the optical-module connectors 202. FIG. 2B is an illustration of the remote serialized radio frequency interface 210 of the SeRF transceiver module 200 of FIG. 2A in accordance with the present invention.

The terms “SeRF transceiver module 200,” “SeRF module 200,” and “circuit card subassembly 200” are use interchangeably herein. The terms “remote serialized radio frequency interface 210,” “remote SeRF interface board 210,” “remote SeRF interface 210,” and “RSI board 210” are use interchangeably herein. The remote serialized radio frequency interface 210 is also referred to herein as “remote multiplexer/serializer interface 210”

The side supports 206 stably hold the SeRF circuit board 220, the remote serialized radio frequency interface 210, and the panel 203 in an operable configuration. The edge connectors 214(1-2) on the RSI board 210 electrically couple the RSI board 210 to the SeRF circuit board 220. The optical connectors 202 are connected to the RIS board 210 via the SeRF circuit board 220.

The circuit card subassembly 200 provides an interconnection between at least one RF module 300 and the optical-module connectors 202 while formatting data being sent to or received from host unit/base station 50 (FIG. 1A). The remote SeRF interface 210 is the interface to the RF modules 300. The remote SeRF interface 210 includes high speed connectors 230 as well as discrete connectors 232, 234, and 236. The internal-monitor cable 719 (FIG. 1D) are connected to a respective one of the high speed connectors 230 on the RSI board 210.

The cable 250 (FIG. 2A) connects the power connector 216 on the panel 203 to the fan connector 232, direct contact general input/output (I/O) connectors 234 and alarm function connector 236 on the RSI board 210. The RSI board 210 provides the received power to the RF modules 300. In one implementation of this embodiment, the direct contact general I/O connectors 234 on remote SeRF interface 210 are used to provide instructions to set the data rates of the remote RF modules 300(1-2). In another implementation of this embodiment, the direct contact general I/O connectors 234 on remote SeRF interface 210 control the output power of the remote RF modules 300(1-2) to the remote antenna 90, and/or control the output power of the remote RF modules 300(1-2) to the remote SeRF transceiver module 200.

The panel 203 includes screw connectors 208 that facilitate the mounting of the SeRF module in the cabinet 102 (FIG. 1C). In this manner, the SeRF transceiver module 200 is attached to the cabinet 102 in a configuration that exposes the optical-module connectors 202 when the cabinet doors 104-1 and 104-2 are opened.

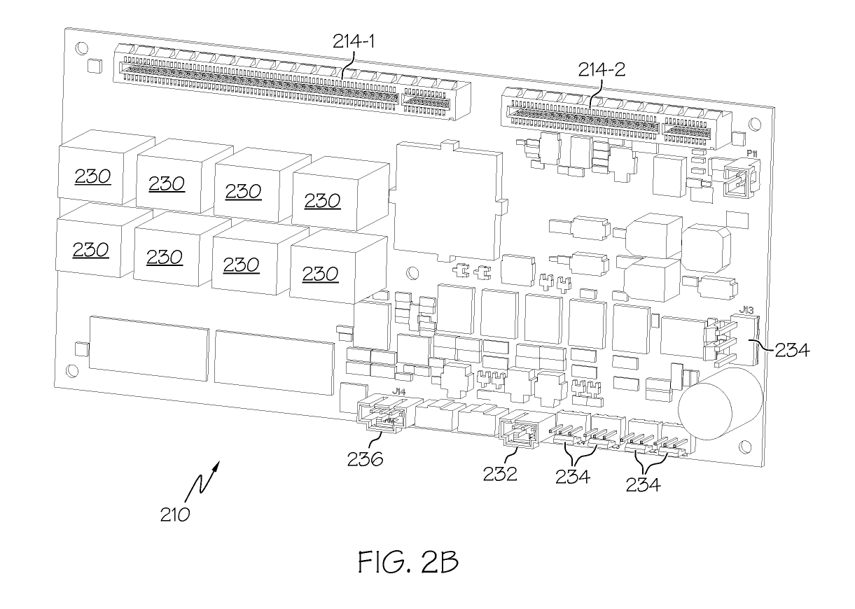

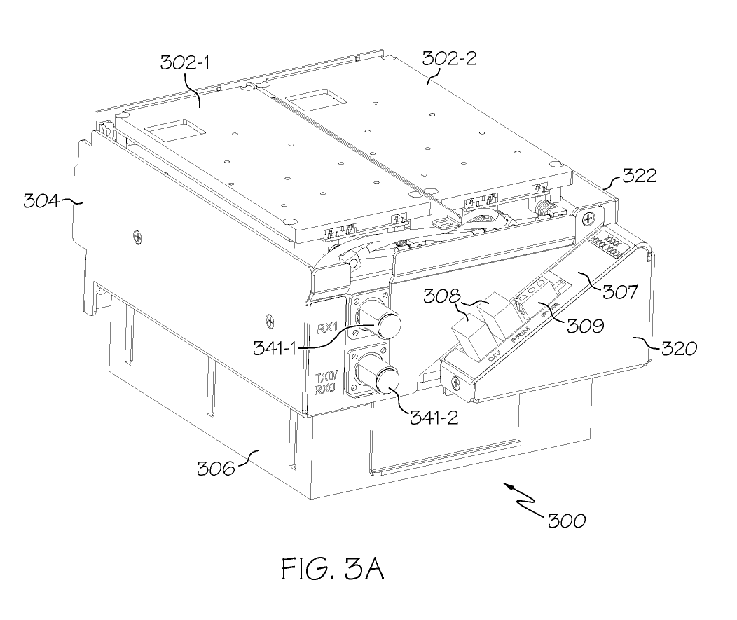

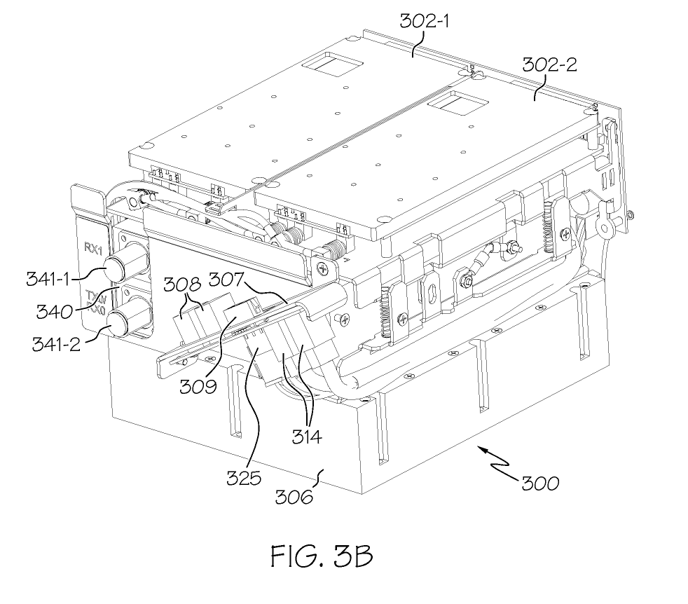

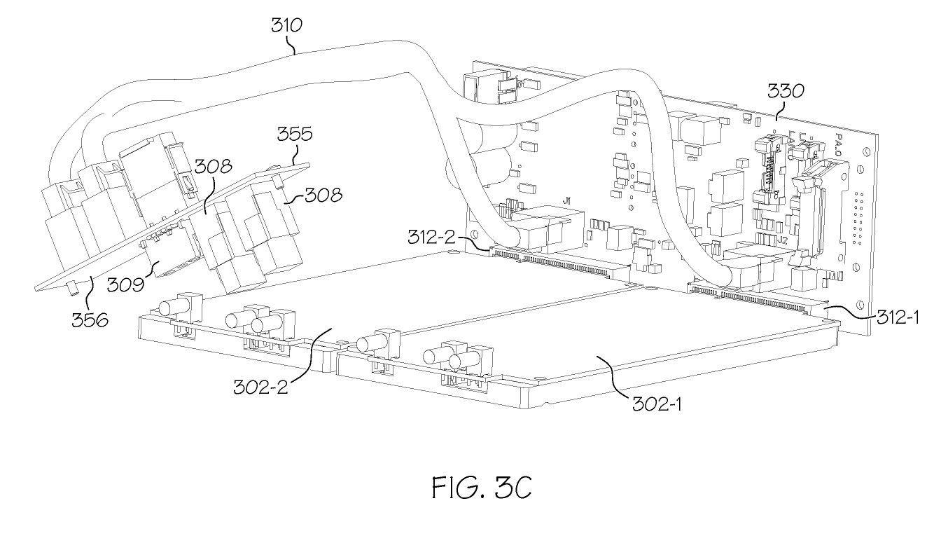

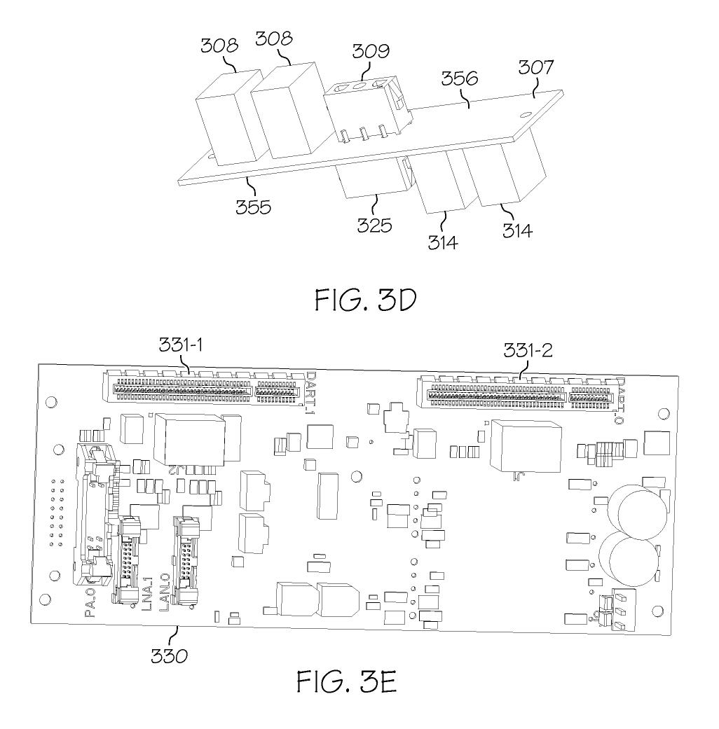

FIG. 3A is a side perspective view of an embodiment of an RF module 300 in accordance with the present invention. The RF module 300 includes transceivers 302(1-2), side panels 320, 322 and 304, a power amplifier 306, a printed circuit board assembly (PCBA) interface 307, and external connectors 308 and 309 on the interface 307. The interface 307 is also referred to herein as “printed circuit board assembly (PCBA) interface 307.” The external connectors 308 and 309 are connected to the remote SeRF interface board 210 of the SeRF module 200 to provide data communication paths between the SeRF module 200 and the RF modules 300. RF signal connectors 341-1 and 341-2 of an RF filter 340 are also shown in FIG. 3A. The antenna 90 (FIG. 1A) is connected to the RF modules 300 via the RF signal connectors 341-1 and 341-2.

FIG. 3B is a side perspective view of the RF module 300 of FIG. 3A with side panel 320 and 322 removed. FIG. 3C is an illustration of the interconnect cables 310 inside an RF module 300 of FIG. 3A. FIG. 3D is an illustration of a printed circuit board assembly (PCBA) interface 307 of the RF module of FIG. 3A. FIG. 3E is an illustration of a remote digital-analog radio transceiver input (RDI) interface 330 of the RF module 300 of FIG. 3A. In order to clearly show the connectors 308, 309, 314, and 327 on PCBA interface 307, the view of the PCBA interface 307 in FIG. 3C is up-side-down with respect to the view of the PCBA interface 307 in FIGS. 3B and 3D. In order to clearly show edge connectors 331-1 and 331-2 on RDI interface 330, the view of the RDI interface 330 in FIG. 3E is up-side-down, with respect to the view of the RDI interface 330 in FIG. 3C. FIGS. 3B and 3C show the routing of interconnect cables 310, which are internal to the RF module 300, between the internal connectors 314 on the PCBA interface 307 and the RDI interface 330. The remote digital-analog radio transceiver input interface 330 is also referred to herein as a “remote radio frequency digitizer input interface 330.”

The external connectors 308 and the module power connector 309 are on an external surface 356 (FIG. 3D) of the PCBA interface 307. The internal connectors 314 are on an internal surface 355 of the PCBA interface 307. The internal connectors 314 are connected to the external connectors 308 via trace lines and/or vias (not shown) in and/or on the PCBA interface 307. In this manner, the data input to the connectors 308 is communicatively coupled to the RDI interface 330 via the PCBA interface 307, internal connectors 314, and interconnect cable 310 (FIG. 3C). The internal connector 325 on the internal surface 355 of the PCBA interface 307 is communicatively coupled to the module power connector 309 on the external surface 356 of the PCBA interface 307. The SeRF transceiver module 200 sends power to module power connector 309 on the RF module 300.

The RDI interface 330 provides internal connections to other components of the RF module 300. Such components include but are not limited to the transceivers 302-1 and 302-2, the RF filter 340, and the power amplifier 306. The transceiver 302-1 plugs into the edge connector 331-1 on RDI interface 330 and the transceiver 302-2 plugs into the edge connector 331-2 on RDI interface 330. By implementing this or like configurations of the RF module 300, the customer does not interface with the complex high speed RDI interface 330 but only with the simple PCBA interface 307 that is easily accessible in the cabinet 102 when the doors 104-1 and 104-2 are open.

Embodiments of the RF module 300 are designed to be easily installed in the enclosure, such as cabinet 102. Once RF Module 300 is installed into the enclosure, connections can be made for: 1) module power at module power connector 309; 2) for high speed digital data at high speed connector 308, and 3) for module radio frequency communication at RF signal connectors 341-1 and 341-2. If an RF module 300 needs to be replaced, the module power connector 309, and the high speed connector 308 on interface 307 and the RF signal connectors 341-1 and 341-2 are simply disconnected and the RF module 300 is removed and replaced.

An embodiment of the operation of the SeRF module 200 on downlink optical signals received from a host unit/base station 50 (FIG. 1A) the cabinet 102 at the optical-module connector 202 (FIG. 1C) is now described. The optical signals received at optical-module connector 202 are converted to electrical signals, which are coupled via the SeRF circuit board 220 to the RSI interface 210. The circuitry in the RSI interface 210 is communicatively coupled to the circuitry in the SeRF circuit board 220 via edge connector 214. The SeRF circuit board 220 serializes the signals which are output via the high speed connectors 230 to interconnect cables 212 outside of the SeRF module 200 but inside the cabinet 102.

The RF module 300 processes the digital data to generate RF signals, which are output to a remote antenna 90 (FIG. 1A) communicatively coupled to the RF signal connectors 341-1 and 341-2. The RDI interface 330 is communicatively coupled to the transceivers 302-1 and 302-2 via edge connectors 331-1 and 331-2, respectively. From the input digital signals, the transceivers 302-1 and 302-2 generate analog RF signals, which are output to an antenna via the RF signal connectors 341-1 and 341-2. In this manner, the information carried by downlink optical signals that are received at optical-module connector 202 is embedded in the RF signals radiated from the remote antenna 90.

In one implementation of this embodiment on the uplink side, the RF signals received at a remote antenna 90 (FIG. 1B) are communicatively coupled to the RF module 300, converted into digital signals in the RF module 300, sent via interconnect cables 212 to the SeRF module 200, serialized at the SeRF module 200, and sent via optical fiber 721 and optical-module connector 202 to a host unit/base station 50.

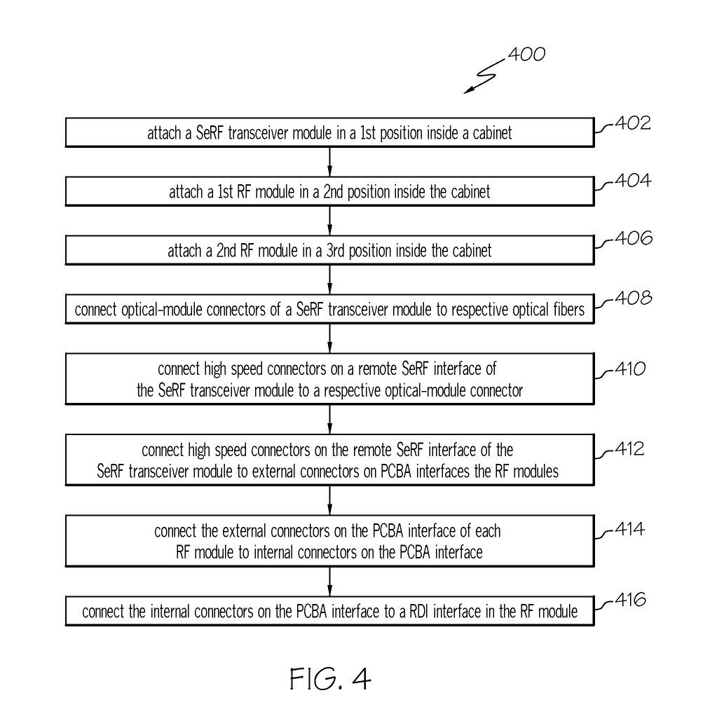

FIG. 4 is a flow diagram of an embodiment of a method 400 of connecting electronic modules 200, 300(1-2) installed in a cabinet 102 to form a communication system 100. This embodiment is described with reference to FIGS. 1A and 1B.

The serialized radio frequency transceiver module 200 is attached in a first position inside the cabinet 102 (block 402). As shown in FIG. 1C, the first position is the bottom position in the cabinet 102. A first radio frequency module 300-1 is attached in a second position inside the cabinet 102 (block 404). As shown in FIG. 1C, the second position is the top position in the cabinet 102. A second radio frequency module 300-2 is attached in a third position inside the cabinet 102 (block 406). As shown in FIG. 1C, the third position is a middle position in the cabinet 102. In one implementation of this embodiment, block 406 is optional and there is only one radio frequency module attached inside the cabinet. In another implementation of this embodiment, there are three or more radio frequency modules attached inside cabinet.

At least one optical-module connector 202 of a serialized radio frequency transceiver module 200 is connected to a respective at least one optical fiber 721 at one end (block 408). The optical fiber 721 is connected at the other end to an optical-cabinet connector 705 to optically couple to the external-optical-fiber cable 720.

At least one optical-module connector 202 is connected to an associated at least one high speed connector 230 on the remote serialized radio frequency interface 210 (block 410). Additionally, if the communication system is being commissioned, tested or upgraded, at least one high speed connector 230 on the remote serialized radio frequency interface 210 of the serialized radio frequency transceiver module 200 is connected to a first end of the internal-monitor cable 719. The internal-monitor cable 719 are attached at the second end to the monitor connector 707 on the cabinet 102 (FIG. 1D).

At least one high speed connector 230 on the remote serialized radio frequency interface 210 of the serialized radio frequency transceiver module 200 is connected to external connectors 308 on a printed circuit board assembly (PCBA) interface 307 on the radio frequency modules 300-1 and 300-2 via interconnect cables 212 (FIG. 1A) (block 412).

The external connectors 308 and 309 on the PCBA interface 307 of the radio frequency module 300 are connected to internal connectors 314 and 325 on the PCBA interface 307 via the PCBA interface 307 (block 414). The internal connectors 314 and 325 on the PCBA interface 307 are connected to a remote digital-analog radio transceiver input interface 330 in the radio frequency module 300 via interconnect cables 310 (block 416).

In this manner, the first and second radio frequency modules 300(1-2) are each communicatively coupled by interconnect cables 212 to send signals to the serialized radio frequency transceiver module 200 and to receive signals from the serialized radio frequency transceiver module 200. The serialized radio frequency transceiver module 200 is communicatively coupled to send signals to and from at least one external-monitor cable 709 that is external to the cabinet 100. The first and second radio frequency modules 300(1-2) are communicatively coupled to send signals to and from at least one antenna 90 external to the cabinet 102.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A communication system, the communication system comprising:
a serialized radio frequency transceiver module including;
a plurality of optical-module connectors, and
a remote serialized radio frequency interface including a plurality of high speed connectors; and
at least one radio frequency module, each radio frequency module including:
an interface configured to be coupled to the remote serialized radio frequency interface of the serialized radio frequency transceiver module to pass and receive data signals, and
a remote digital-analog radio transceiver input interface coupled to the interface, wherein the remote serialized radio frequency interface passes data signals to and from the at least one radio frequency module.

2. The communication system of claim 1, wherein the serialized radio frequency transceiver module further comprises:
a serialized radio frequency circuit board to communicatively couple the plurality of optical-module connectors to the remote serialized radio frequency interface.

3. The communication system of claim 2, wherein the remote serialized radio frequency interface comprises at least one edge connector to communicatively couple the serialized radio frequency circuit board to the remote serialized radio frequency interface.

4. The communication system of claim 1, wherein the remote serialized radio frequency interface further includes:
a fan connector; and
a direct contact input/output connector.

5. The communication system of claim 4, wherein the remote serialized radio frequency interface further comprises an alarm function connector.

6. The communication system of claim 1, wherein the serialized radio frequency transceiver module further comprises:
screw connectors to mount the serialized radio frequency transceiver module in a cabinet, wherein the serialized radio frequency transceiver module and the at least one radio frequency module are housed in the cabinet.

7. The communication system of claim 1, further comprising a cabinet, wherein the at least one radio frequency module is attached inside of the cabinet, wherein the serialized radio frequency transceiver module is attached inside of the cabinet, and wherein the remote serialized radio frequency interface of the serialized radio frequency transceiver module is operably connected via an interconnect cable to the interface in each radio frequency module housed in the cabinet.

8. The communication system of claim 7, wherein cabinet comprises:
an optical-cabinet connector on a panel of the cabinet, the optical-cabinet connector configured to connect an external-optical-fiber cable carrying optical signals to the communication system; and
at least one monitor connector on the panel, the at least one monitor connector configured to connect an external-monitor cable carrying monitoring signals to the communication system.

9. The communication system of claim 8, further comprising at least one optical fiber to communicatively couple to a respective one of the plurality of optical-module connectors, wherein optical signals received via the external-optical-fiber cable are converted by a serialized radio frequency circuit board in the serialized radio frequency transceiver module into formatted digital signals, wherein formatted digital signals associated with the optical signals are passed from the remote serialized radio frequency interface in the serialized radio frequency transceiver module the interface in the at least one radio frequency modules, and wherein the radio frequency module converts the formatted digital signals into radio frequency signals.

10. The communication system of claim 9, further comprising at least one internal-monitor cable communicatively coupled to receive signals from the at least one external-monitor cable and communicatively coupled to pass the received monitoring signals to a respective one of the plurality of high speed connectors, wherein formatted digital signals associated the monitoring signals are passed from the remote serialized radio frequency interface in the serialized radio frequency transceiver module to the interface in the at least one the radio frequency module.

11. The communication system of claim 1, wherein the plurality of optical-module connectors are optical transceivers.

12. The communication system of claim 1, wherein the interface is a printed circuit board assembly interface.

13. A serialized radio frequency transceiver module comprising:
a plurality of optical-module connectors;
a remote serialized radio frequency interface including a plurality of high speed connectors, at least one of the plurality of high speed connectors being communicatively coupled to a respective one of the plurality of optical-module connectors; and
a serialized radio frequency circuit board communicatively coupling the plurality of optical-module connectors to the remote serialized radio frequency interface, wherein the serialized radio frequency transceiver module is configured to pass signals to and from at least one radio frequency module housed in a cabinet with the serialized radio frequency transceiver module.

14. The serialized radio frequency transceiver module of claim 13, wherein the remote serialized radio frequency interface comprises:
at least one edge connector to communicatively couple the serialized radio frequency circuit board to the remote serialized radio frequency interface.

15. The serialized radio frequency transceiver module of claim 14, wherein the remote serialized radio frequency interface further includes:
a fan connector;
a direct contact input/output connector; and
an alarm function connector.

16. The serialized radio frequency transceiver module of claim 13, further comprising screw connectors to mount the serialized radio frequency transceiver module in the cabinet, wherein the serialized radio frequency transceiver module and the at least one radio frequency module are housed in the cabinet.

17. The serialized radio frequency transceiver module of claim 13, wherein the serialized radio frequency transceiver module converts the optical signals received at the plurality of optical-module connectors into formatted digital signals that are passed from the remote serialized radio frequency interface to an interface in one of the at least one radio frequency modules, wherein the radio frequency module converts the received formatted digital signals into radio frequency signals.

18. The serialized radio frequency transceiver module of claim 13, wherein the plurality of high speed connectors are configured to receive monitoring signals to provide support to the serialized radio frequency transceiver module and the at least one radio frequency module.

19. A method of connecting electronic modules installed in a cabinet, wherein the installed electronic modules comprise a communication system, the method comprising:
connecting at least one optical-module connector of a serialized radio frequency transceiver module to a respective at least one optical fiber;
connecting the at least one optical-module connector to an associated at least one high speed connector on a remote serialized radio frequency interface of the serialized radio frequency transceiver module; and
connecting the at least one high speed connector on the remote serialized radio frequency interface to external connectors on an interface of a radio frequency module via interconnect cables, wherein the radio frequency module and the serialized radio frequency transceiver module are communicatively coupled to send signals to and from each other, wherein the serialized radio frequency transceiver module is communicatively coupled to send signals to and from at least one external-optical-fiber cable, and wherein the radio frequency module is communicatively coupled to send signals to and from at least one antenna.

20. The method of claim 19, further comprising connecting the at least one optical fiber to a respective at least one optical-cabinet connector.

21. The method of claim 19, further comprising:
connecting the at least one high speed connector on the remote serialized radio frequency interface to at least one monitor connector via at least one respective internal-monitor cable; and
connecting the at least one internal-monitor cable to a respective at least one external-monitor cable via a monitor connector.

22. The method of claim 19, wherein the interface of the radio frequency module is a printed circuit board assembly interface, the method further comprising:
connecting the external connectors on the printed circuit board assembly interface to internal connectors on the printed circuit board assembly interface via the printed circuit board assembly interface; and
connecting the internal connectors on the printed circuit board assembly interface to a remote digital-analog radio transceiver input interface of the radio frequency module via interconnect cables.

23. The method claim 19, the method further comprising:
attaching the serialized radio frequency transceiver module in a first position inside the cabinet; and
attaching the radio frequency module in a second position inside the cabinet.

24. The method claim 23, wherein the radio frequency module is a first radio frequency module, the method further comprising attaching a second radio frequency module in a third position inside the cabinet, the second radio frequency module configured to be connected to at least one high speed connector on the remote serialized radio frequency interface of the serialized radio frequency transceiver module, wherein the second radio frequency module and the serialized radio frequency transceiver module are communicatively coupled to send signals to and from each other, and wherein the second radio frequency module is communicatively coupled to send signals to and from the at least one antenna.

25. A communication system, the communication system comprising:
a multiplexer/serializer module including:
a plurality of optical-module connectors, and
a remote multiplexer/serializer interface including a plurality of high speed connectors; and
at least one radio frequency digitizer module, each radio frequency module including:
an interface configured to be coupled to the remote multiplexer/serializer interface of the multiplexer/serializer module to pass and receive data signals, and
a remote radio frequency digitizer input interface coupled to the interface, wherein the remote multiplexer/serializer interface passes data signals to and from the at least one radio frequency digitizer module.

26. The communication system of claim 25, wherein the multiplexer/serializer module further comprises:
a serialized radio frequency circuit board to communicatively couple the plurality of optical-module connectors to the remote multiplexer/serializer interface.

27. The communication system of claim 26, wherein the remote multiplexer/serializer interface comprises at least one edge connector to communicatively couple the serialized radio frequency circuit board to the remote multiplexer/serializer interface.
